(19) United States
(12) Patent Application Publication
(10) Pub. No.: US 2011/0143301 A1
(43) Pub. Date: Jun. 16, 2011

(54) SINGLE CONTINUOUS SPRING ORTHODONTIC BRACKET AND SYSTEM

(75) Inventors: Rolf Maijer, Victoria (CA); Dwight Schnaitter, Parker, CO (US)

(73) Assignee: Rolf Maijer, Victoria, BC (CA)

(21) Appl. No.: 12/673,746

(22) PCT Filed: Aug. 18, 2008
(86) PCT No.: PCT/CA08/01475

§ 371 Date: Feb. 11, 2011

Related U.S. Application Data
(60) Provisional application No. 60/935,533, filed on Aug. 17, 2007.

(51) Int. Cl. A61C 7/30

(52) U.S. Cl. 433/11

(57) ABSTRACT

A novel orthodontic bracket system comprised of orthodontic appliances, such as brackets or buccal tubes, with a buccal-labial slot orientation. Brackets in the system include a base for bonding the appliance to a tooth and a body extending from the base. An arch wire slot extends across the body in a generally mesial-distal direction and opens in a generally buccal-labial direction. The body has a chamfer that widens the arch wire slot at its opening. A resilient retention device such as a spring is associated with the slot and has a terminal portion opposite the chamfer when in a resting position to permit both entry and removal of an arch wire from said slot. The arch wire retention device is designed to guide, retain and/or seat the arch wire in cooperation with the arch wire slot, and in cooperation with the chamfer permits entry or release of the arch wire from the arch wire slot as the arch wire is moved along the chamfer.

### FIELD OF THE INVENTION

This invention broadly relates to an appliance primarily but not exclusively used in orthodontic treatment. More particularly, the present invention relates to an orthodontic appliance, such as a bracket or buccal tube, which has a horizontally opening arch wire slot and an arch wire retention device for retaining and releasing an arch wire in the arch wire slot.

### BACKGROUND OF THE INVENTION

Orthodontic therapy is a specialized type of treatment within the field of dentistry, which involves movement of malpositioned teeth to functionally improved and correct locations. Orthodontic treatment often improves the patient's occlusion (i.e. bite) and typically enhances the aesthetic appearance of the teeth.

Many types of fixed orthodontic treatment programs involve the use of a set of tiny appliances known as brackets and wires that are collectively known as “braces”.

Most orthodontic brackets have arch wire slots that are open on one side for insertion of the arch wire. The typical location of the arch wire slot is horizontal, and runs from a mesial to distal location. The wire is inserted from the buccal/labial (i.e., cheek/lip side, referred to sometimes in the art as the “facial” side) to the lingual (i.e., tongue side) direction. The wire is bounded on occlusal (i.e., the side facing the tips of the patient's teeth) and gingival (i.e., the side facing the patient's gingiva or gums) sides by walls or functionally similar structures.

Many orthodontists use small thin wires, known as stainless steel ligatures, to secure the arch wire in the arch wire slot. A metal ligature is hooked around small wings (known as tiewings) that are connected to the bracket body on the gingival side and on the occlusal side of the arch wire slot. The metal ligature is extended over the labial side of the arch wire, and its end sections are twisted together and pulled tight to form a loop thereby to retain the arch wire in place. The extent of the force applied by the stainless steel ligature depends upon the technique employed during its installation.

Another way to secure the arch wire in the arch wire slot is to employ a small, elastomeric O-ring. Orthodontic O-rings are stretched around the tiewings. Once installed, the O-ring ligature extends around the tiewings as well as over the buccal-labial surface of the arch wire and exerts pressure on the arch wire to reach a fully seated position in contact with a lingual wall of the arch wire slot.

Elastomeric ligatures can suffer from force decay and staining, while metal ligatures often have sharp ends that may retain food, irritate cheek and gum tissue, and increase the risk of infection caused by puncture of an operators tissue through a glove-covered hand.

To solve some of the above mentioned ligation problems, a variety of orthodontic brackets have been proposed having various types of clips or latches for securing the arch wire in the bracket. These brackets are commonly known as self-ligating brackets. The latch comprises a clip, spring member, cover, shutter, bail or other structure that is connected to the bracket body for retaining an arch wire in the arch wire slot. This type of self-ligating securing technique potentially eliminates the need for elastomeric or metal ligatures to secure the arch wire. As a result, there is reduced infection and cheek and gum irritation.

In general, there are three types of tooth movement that are important to orthodontic practitioners. Rotational movement, as its name suggests, is rotational movement of a tooth about its long axis. Tipping movement is another type, where the movement is primarily of the clinical crown, with minimal movement of the root tip. A third type is torquing movement, which can be defined as pivotal movement of the long axis of a tooth in a buccal-lingual direction. Preferably, the appliances selected by the practitioner for use provide precise control over movement of the associated teeth for each type of tooth movement. During the course of treatment, it may be necessary to shift each tooth relative to adjacent teeth in order to provide an aesthetically pleasing and functional result at the conclusion of treatment.

It is customary to use a small flexible round wire to accomplish the task of leveling and aligning of the teeth. The small round wire is easily inserted in an arch wire slot in either door or latch style self ligating systems because it is smaller in dimension than the rectangular arch wire slot. As treatment progresses and the next phase of therapy is undertaken, a larger square or rectangular arch wire is employed for initial torque correction of the crowns. Depending on the tooth position and the cross-sectional size of the square or rectangular arch wire, inserting the wire in a latch style system or closing the doors in a door style system is more difficult than with the small round wire. It is time-consuming to seat the larger wires, and special tools are often required.

Precise control over movement of the teeth is desirable so that each tooth can be shifted as needed to its ideal orientation. It is desirable that this be done with a minimum of friction on the arch wire. Prior art self-ligating orthodontic brackets are not entirely satisfactory because optimal control over torquing movement as described above is often difficult to achieve. Also, making the procedure of arch wire insertion more difficult for practitioners is the “torque differential” between brackets. In a straight wire system, brackets have different torque values as appropriate for correction. The various torque values vary in increments from 1 degree up to a maximum of 10 degrees.

For example, in the lower arch the lower central and lateral brackets are very close together because the teeth are very narrow. The limited inter-bracket distance requires that the arch wire be considerably deformed within a very short length. While teeth are larger in the posterior of the mandibular arch and the brackets accordingly farther apart, the torque differential is larger. The torque differential between the lower 1^{st} and 2^{nd} molars is 10 degrees and 6 degrees between lower 1^{st} and 2^{nd} bicuspids. In the maxillary arch the torque differentials vary by as much as 10 degrees between the laterals and cuspids and 7 degrees between the cuspids and 1^{st} bicuspids. Although there is slightly more interbracket distance between these teeth, required torque in the upper arch can be high.

The torque differentials described above require deformation against a considerable amount of resistance of the rectangular or square arch wire in the torquing plane. As a result, it can be difficult or impossible in certain stages of treatment for a practitioner to force an arch wire past a resistant latch or otherwise close the door behind an arch wire without debonding the bracket or causing severe patient discomfort. Specialty tools or modified arch wires are often required to overcome these difficulties.

Examples of such specialty tools include insertion and disengagement tools offered by 3M Innovative Properties Company, of St. Paul, Minn., U.S.A. 3M also offers rectangular arch wires with rounded edges for reducing contact point interference, binding and notching. GAC International, Inc. of Bohemia, N.Y., U.S.A. offers specialty tools for opening and closing clips on their In-Ovation-R™ line of self-ligating brackets. Ormco of Orange, Calif., U.S.A. offer specialty tools for opening and closing doors on their Damon™ line of brackets.

Prior art latch-style and door-style self-ligating systems generally include, with some exceptions, brackets with one of two standard slot cross-sectional sizes. These are 0.0185×0.025 inches or 0.0225×0.0285 inches. Common finishing arch wire sizes range from 0.016×0.016 to 0.017×0.025 inches in a 0.0185×0.025 slot. In a 0.0225×0.0285 slot common finishing wires are 0.017×0.017, 0.018×0.025, 0.019×0.025 and 0.021×0.025. It is known that in order for an orthodontist to express the torque adequately for desired tooth position, depending on the treatment requirements a square or rectangular arch wire must fill at least 60% to 80% and higher of the slot. Because the slot must be filled as described, there are special requirements and specialty tools for installing the existing self-ligating systems.

Another problem that has been noted in connection with conventional direct-bonded appliances, including self-ligating brackets, is the possibility that such brackets may spontaneously debond from the patient's tooth when the teeth are severely maloccluded. When the teeth are severely maloccluded or excessive torque is applied, for example, if one of the patient's teeth is located a relatively large distance in a lingual direction relative to adjacent teeth in the dental arch, the arch wire must be deformed a significant distance in order to be engaged in the arch wire slot. In such instances, the inherent tendency of the arch wire to return to its normal arch-shaped configuration may cause the arch wire to exert a substantial force and/or torque on the appliance bonded to the severely maloccluded tooth. Unfortunately, the bracket may then debond from the tooth if the arch wire exerts a force that is larger than the force required to retain the bracket.

Brackets that spontaneously debond from teeth represent a waste of time and expense for both the practitioner and the patient, and are best avoided if at all possible.

While many types of self-ligating orthodontic appliances have been proposed in the past, there remains a continuing need to improve the state of the art of self-ligating systems. For example, it would be desirable to provide a self-ligating appliance that reduces the time needed for installation of an arch wire in comparison with existing self-ligating brackets, so that the time of both the practitioner as well as the patient to complete the installation procedure can be reduced. Commercially available self-ligating systems feature an arch wire slot oriented horizontally generally parallel to the occlusal plane. Most of these devices have self-ligating mechanisms, such as latches or hinges that open and lock in a vertical or horizontal direction relative to the occlusal plane. Most clip and hinge devices currently commercially available have proven to be difficult to open in the posterior region of the mouth. This is due to the limited working space available between the patients' cheeks and the buccally-oriented entrance of arch wire slot. As has been described, most of these devices require specially designed instruments to insert the arch wire and close the latch or hinge, securing the arch wire in the horizontal slot. Other self-ligating systems require a special tool to pry the arch wire from the arch wire slot releasing it from the horizontal arch wire slot of each bracket.

Furthermore, prior art self-ligating systems incorporate ligation mechanisms that retain an arch wire in the arch wire slot that completely or nearly completely cover the slot entrance. As such, when the arch wire slot is covered by the ligation mechanism (a door or latch) the arch wire slot opening is totally closed, or open minutely. These self ligating systems each require that the doors be opened entirely or latches opened and deformed to the cross section size of the wire in order to gain slot entrance. In cases where significant torque is required these doors can interfere or produce excessive friction with the effective use of the arch wire

For example, U.S. Pat. No. 6,582,226 discloses a number of orthodontic brackets/buccal tubes, each having an arch wire slot running across the body in a generally mesial-distal direction with a slot opening in a generally labio-lingual (horizontal) direction. A shutter retains an arch wire in the arch wire slot. In each of the embodiments shown, the shutter is sufficiently resilient to enable an arch wire to be pushed into the slot by a user, while retaining the arch wire within the slot until a predetermined minimum force applied by the arch wire against the shutter is exceeded. The shutter must be deflected entirely to open the cross-sectional area of the slot for arch wire insertion. However, the configurations shown are limited to requiring use of smaller-diameter wires throughout the entire system, since a larger diameter wire would not be held effectively by the shutter in the case of a severe malocclusion. Also, because of the configuration of the shutters relative to the slot opening, whereby the ends of the shutters protrude from above and below into the slot opening, a large force is required to deflect the shutters into the slot to a slot-open position. Therefore, once the arch wire is pushed past the shutters into or out of the slot, the shutters snap sharply back to their normal shape. In practice, the large snapping force is transmitted rather efficiently to the patient's tooth through the body of the appliance, causing discomfort.

Discomfort for the patient is also caused in practice by use of the c-clips proposed in the '226 patent. The configuration of the c-clips is such that two arm portions are connected by a backbone portion. In practice, due to the rigid backbone connecting the two arm portions, it is very difficult for a practitioner to deflect the arms apart for entry and exit of an arch wire. Specialty tools therefore are required as disclosed in the '226 patent for entry and removal of the arch wire. Even with use of the specialty tools, in practice the c-clips also tend to snap back with a large force to their normal shape after having been forced apart. The force of the snap is transmitted ultimately to the patient's tooth.

Furthermore, with the devices in the '226 patent mentioned above, control and expression of forces, particularly torque, is limited because their configurations only express torque efficiently when a full-sized finishing arch wire is in place. This is because the c-clips are limited by their configuration with respect to the arch wire slot to be able to contact only full size finishing arch wires, when in the slot. It is proposed in the '226 patent to use two sets of c-clips at the same time, each set having a different size, to retain and fully express torque to smaller arch wires while being able to accommodate full size arch wires. However, use of multiple c-clip sets of different sizes at the same time clearly causes unnecessary friction on a larger arch wire because both the larger and smaller c-clip sets remain in contact with the inserted arch wire during treatment. Furthermore, the use of multiple c-clip sets clearly increases the size and expense of the device.

### SUMMARY OF THE INVENTION

Both a novel orthodontic appliance and a system comprising a plurality of the appliances as well as new designs in arch wires are disclosed herein. The appliance includes a base for bonding the appliance to a tooth, and a body extending from the base. An arch wire slot extends across the body in a generally mesial-distal direction and opens in a generally buccal-labial direction. The body has a chamfer that widens the arch wire slot at its opening. A resilient retention device is associated with the slot and has a terminal portion opposite the chamfer when in a resting position to permit both entry and removal of an arch wire from the slot.

According to an embodiment, the retention device is a spring that is easily deflected. The sum total force of all of the springs in the system's brackets cooperate to retain an arch wire in the arch wire slots of the brackets in the upper and or lower dentition. En masse insertion and removal of the arch wire occurs after the initial correction or leveling and aligning phase of treatment.

The arch wire is releasably retained by the retention device in the arch wire slot without requiring manual ligation using O-rings, stainless steel ligatures and the like.

Preferably, the retention device comprises a spring for exerting force on a retained arch wire having a predetermined minimum dimension to seat the retained arch wire in the arch wire slot. The spring is beneficial for providing efficient transmission of force, particularly torque, from an arch wire to the tooth via the orthodontic appliance. Retained arch wires having less than the predetermined minimum dimension are relatively free to slide within the slot for the initial leveling and aligning phases of treatment.

Pressure by an operator on the spring through the arch wire allows the arch wire to be released from the arch wire slot, whenever a certain force is exerted to the arch wire or a force is applied to the spring or springs that exceeds a certain minimum value. The force to release the wire is significantly less than the force required in the same direction to debond the appliance from the tooth, and consequently helps ensure that the appliance will not spontaneously debond from the tooth during the course of treatment.

Use of the spring system also ensures that the maximum force exerted by the appliance on the patient's tooth can be limited to a pre-selected, biologically acceptable range. As a result, the amount of discomfort experienced by the patient due to excessive forces exerted by the appliance is also limited during the initial torquing phase. The spring also helps reduce undue force on root portions of the associated tooth so that blood vessels adjacent to the root portions are not adversely affected (i.e. root resorption is reduced).

Because the retention device releasably retains an arch wire without totally latching or covering the arch wire slot, the arch wire retention device's spring permits fast, predictable, consistent and efficient insertion and removal of arch wires to and from the arch wire slot during treatment.

The arch wire retention spring in combination with the pressure of shape memory arch wires allows very light forces to be used to effectively correct the patient's malocclusion.

Superelastic thermally activated nickel titanium square and rectangular arch wires, preferably employed herein, with the larger cross section oriented horizontally, provide gentle incremental initial torquing forces and more biologically compatible tooth movement in interaction with the arch wire retention spring(s).

The brackets are excellent for manufacture as part of a “straight wire” system with preadjusted in/out thicknesses, torque values, rotation values and angulation values to minimize arch wire bending necessary to position a patient's teeth ideally.

These and other aspects of the invention are described in more detail below and are illustrated in the accompanying drawings.

### BRIEF DESCRIPTION OF THE DRAWINGS

FIG. 1 is a side view of an orthodontic bracket according to one embodiment;

FIG. 2 is a side view of the orthodontic bracket of FIG. 1, illustrating an offset of the tie wings for easing insertion of an arch wire into its arch wire slot;

FIG. 3 is a front view of the orthodontic bracket of FIG. 1, illustrating reception of an arch wire in the arch wire slot;

FIG. 4 is a rear view of the orthodontic bracket of FIG. 1, illustrating reception of an arch wire in the arch wire slot;

FIG. 5 is an elevational view of a single spring used in the bracket of FIG. 1 having been stamped from nickel titanium or steel and then formed for association with the bracket;

FIG. 6 is a perspective view of an extruded rectangular nickel titanium tube and the means by which the single spring in FIG. 1 may be laser cut from the tube;

FIG. 7 shows side views of the orthodontic bracket of FIG. 1, having received a small round arch wire and an oval arch wire in its arch wire slot;

FIG. 8 shows side views of the orthodontic bracket of FIG. 1, receiving a novel six-side finishing arch wire in its arch wire slot;

FIG. 9 is a front view of an orthodontic bracket according to an alternative embodiment, having received an arch wire in its arch wire slot;

FIG. 10 is a rear view of the orthodontic bracket of FIG. 9;

FIG. 11 shows side views of the orthodontic bracket of FIG. 9, having received a round arch wire and an oval arch wire in its arch wire slot;

FIG. 12 shows side views of the orthodontic bracket of FIG. 9, receiving a six-sided finishing arch wire in its arch wire slot;

FIG. 13 is a front view of an orthodontic bracket according to another alternative embodiment with an arch wire ready for insertion into its arch wire slot;

FIG. 14 is a side view of the orthodontic bracket of FIG. 13 with an arch wire being inserted into its arch wire slot;

FIG. 15 is a slightly raised side view of the orthodontic bracket of FIG. 13 with the arch wire being inserted into its arch wire slot;

FIG. 16 is a side view of the orthodontic bracket of FIG. 13 with the arch wire having been inserted into its arch wire slot;

FIG. 17 is a side view of the orthodontic bracket of FIG. 13 with the arch wire having been inserted into its arch wire slot and showing the dimension of the retention device for retaining the arch wire and the chamfer of the gingival tie wings;

FIG. 18 is an occlusal sectional view of the orthodontic bracket of FIG. 13 showing the relationship between the body of the bracket and the retention device;

FIG. 19 is occlusal views of the bracket FIG. 13 formed of ceramic and having a metal insert for receiving the retention device;

FIG. 20 is a side view of an orthodontic bracket according to an alternative embodiment; and

FIG. 21 is a front view of an orthodontic bracket according to an alternative embodiment, having dual L-shaped terminal portions, and having received an arch wire in its arch wire slot.

### DESCRIPTION OF PREFERRED EMBODIMENTS

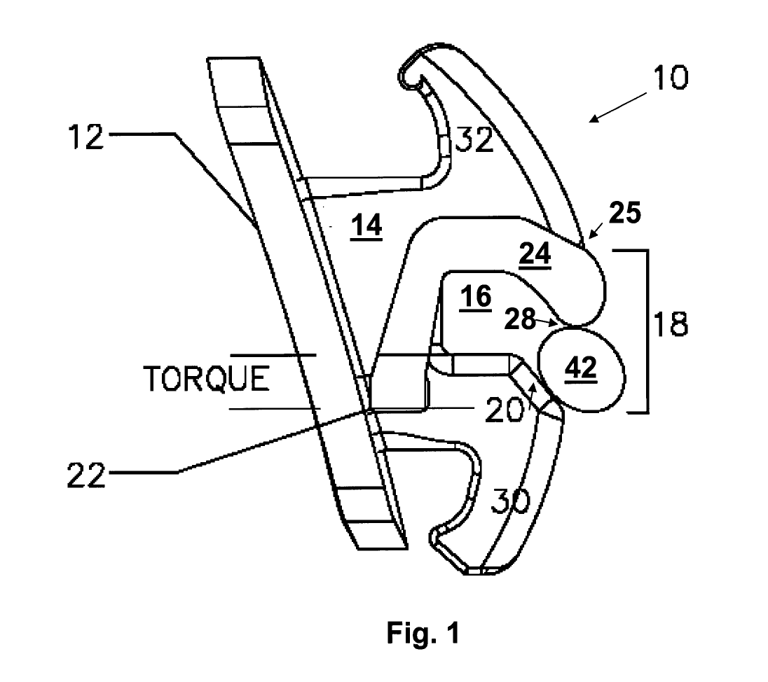

FIG. 1 is a side view of an orthodontic bracket 10 according to one embodiment. The orthodontic bracket 10 includes a bonding pad (or “base”) 12 adapted to face and be bonded to a patient's tooth (not shown) in a known manner. Welded to the base 12 is the bracket's body 14. Extending across the body 14 is the arch wire slot 16 which extends in a mesial-distal direction and has an opening 18 in a buccal-labial, or generally horizontal, direction. The body 14 includes a chamfer 20 at the slot opening 18 that serves to create a ramp and thereby widen the arch wire slot 16 at its opening 18. The chamfer 20 is at an angle of between 5 and 60 degrees relative to the adjacent wall of the archwire slot 16, more typically between 30 and 40 degrees.

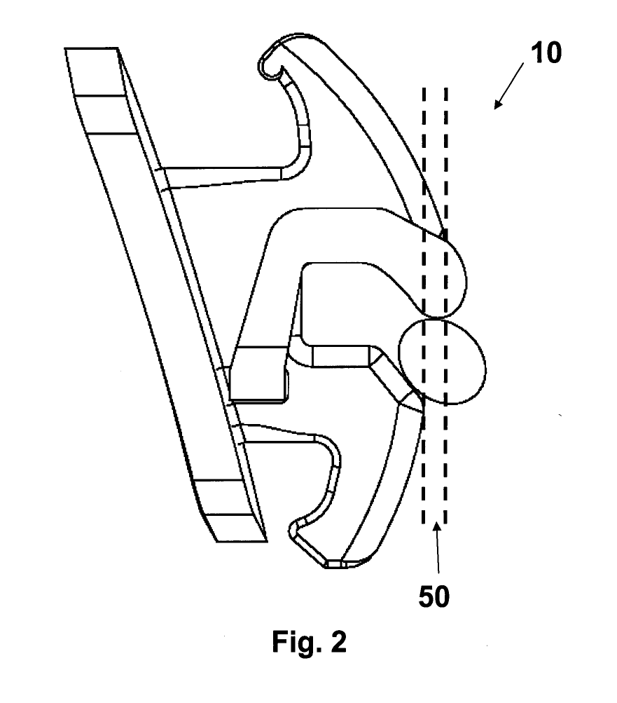

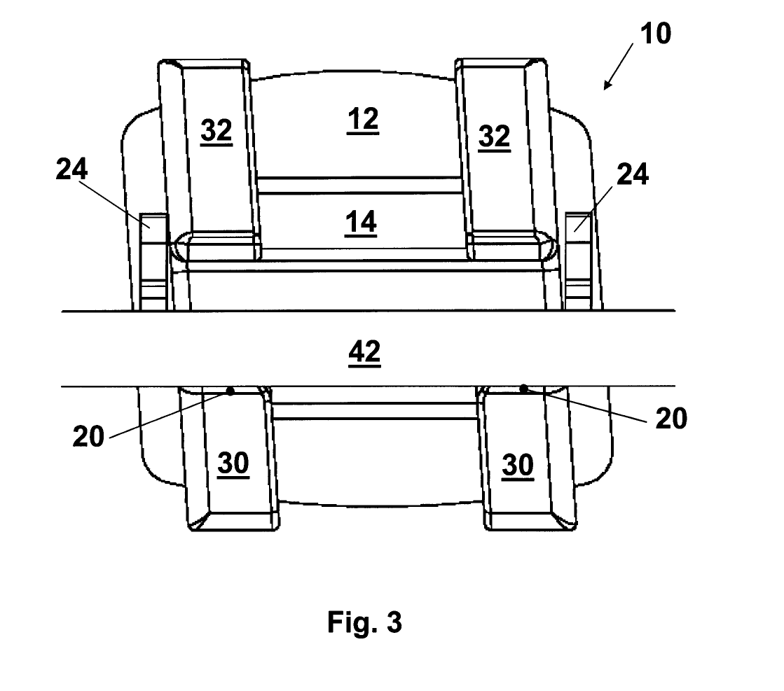

The retention device according to this embodiment is a spring 24 with two fingers 25 outside of the arch wire slot 16 on a respective mesial/distal side of the body 14. The fingers 25 are integral, being connected by a mesial-distal web 26 that passes through a spring slot 22 in the body 14. The fingers 25 are generally J-shaped and curve down to respective terminal portions (tips) 28 so as to partially block the midsection of arch wire slot 16 and the slot opening 18 (when viewed from the side as shown in FIGS. 1 and 2, or the front as shown in FIG. 3). An oval arch wire 42 is shown resting at the slot opening 18. The curved tips of the spring fingers 25 are dimensioned and positioned relative to the arch wire slot 16 not only to contact and fully seat a full size finishing arch wire, but also to provide varying degrees of contact with smaller arch wires and those having different shapes (i.e. square, round, oval, 5-sided, 6-sided etc.). The contact with varying sizes of inserted arch wires is provided by way of the terminal portions 28 extending downwards to slightly block the mesial and distal ends of the arch wire slot 16 cross-sectionally at both its opening and part of its midsection. According to this embodiment, the terminal portions 25 when viewed cross-sectionally are spaced from the opposite wall of the arch wire slot 16 by a maximum of 0.008 inches in order to retain an arch wire 42 that is only slightly wider than 0.008 inches. It will be understood that according to alternative embodiments the maximum spacing, depending upon the expected dimensions of the standard or special arch wires to be used, could be up to 0.013 inches, or more.

Because part of the midsection of the arch wire slot 16 is blocked when viewed from the side of the bracket 10, the spring fingers 25 serve not merely to retain an arch wire 42 but also to contact the arch wire 42 while retained thereby expressing varying degrees of force to the bracket, depending upon the arch wire chosen. It can be seen that the single continuous spring 24 cooperates with the walls of the arch wire slot 16 to retain and provide varying degrees of seating of different sized arch wires, from the small round arch wires 40 used for leveling and aligning to the larger finishing arch wires. This enables efficient control over gradual correction of the tooth. During treatment, arch wires of different wire stiffness and sizes may be retained and seated in order to incrementally provide increased expression of the torque, tipping and rotational forces required to move the teeth to their ideal position.

When viewed from the side, the tips 28 of the spring fingers 25 are opposite the chamfer 20. The tips 28 also have a smoothly curved surface.

Gingival and occlusal tiewings 32, 30 extend from the body 14 and provide other ligation options such as conventional manual ligation using O-rings or the like, if desired by a clinician. The top of the gingival tie wings 32, corresponding to the gingival wall of the arch wire slot 16, extend slightly farther in a buccal-labial direction than the top of the occlusal tie wings 30 corresponding to the occlusal wall of the arch wire slot 16. The offset, shown clearly in FIG. 2, provides a convenient resting place for the arch wire 42 for partial placement into the arch wire slot 16 without full insertion and without deflecting, or significantly deflecting, the spring 24. The use of this resting place will be described below.

During arch wire insertion, for each bracket 10 in a system, the arch wire 42 is pushed from its resting place up the chamfer 20 thereby to slide the arch wire 42 upwards and under the terminal portions 28 of the fingers 25 of spring 24. As the arch wire 42 is pushed farther up the chamfer 20, it continuously deflects the spring 24 upwards just enough to enable the arch wire 42 to fully pass into the arch wire slot 16. The curved surfaces of the terminal portions 28 of the fingers 25 cooperate with the arch wire 42 to smoothly slide up, over and down the arch wire 42 during entry as the arch wire 42 is pushed up the chamfer 20 so as to smoothly deflect and return the spring 24 to its resting position rather than snap back into the resting position. This smooth insertion/removal effect in combination with the low deflection force required of each individual spring 24 provides for comfortable experience for a patient when an arch wire 42 is being inserted or removed, when compared with other devices known in the art.

It will be understood that over the duration of treatment, different sizes and shapes of arch wires will be employed in order to efficiently move the teeth as desired.

For example, an oval arch wire 42 provides a clinician with gradual control over torquing forces, in particular. Some rotation generally about a mesial-distal axis by the oval arch wire 42 is possible as treatment progresses because the spring enables some degree of both labio-lingual and occlusal-gingival movement of the oval arch wire 42 with respect to the bracket 10. This provides for leveling, rotation and initial torquing forces while at the same time preventing absolute rigidity and restrictive binding in the arch wire slot 16.

A rectangular arch wire (not shown) provides a user with still further increased control over torquing forces, in particular. A light constant force is applied by the spring 24 against the arch wire, which force gradually expresses the prescriptive torque value of the bracket 10.

A 5-sided arch wire 44 provides maximum control over torquing forces, in particular. The spring 24 fully seats the arch wire in the arch wire slot. A 5-sided arch wire 44 can be used in the end/finishing stages of treatment.

As can be seen, the spring 24 functions in conjunction with the walls of the arch wire slot 16 to retain an arch wire. Where the arch wire is large enough, the spring 24 engages the arch wire and provides partial or full seating and accordingly, torque transmission due to being held by an arch wire against its rest position bias. The bracket 10 therefore gently seats an arch wire in its arch wire slot 16 to gently move the tooth appropriately under influence of the spring bias to its correct position.

As can be seen particularly from the front view of the orthodontic bracket shown in FIG. 3, in which the orthodontic bracket is retaining an arch wire 42, the spring 24 straddles the bracket body such that one finger 25 is on a mesial side of the arch wire slot 16 and the other finger 25 is on a distal side of the arch wire slot 16.

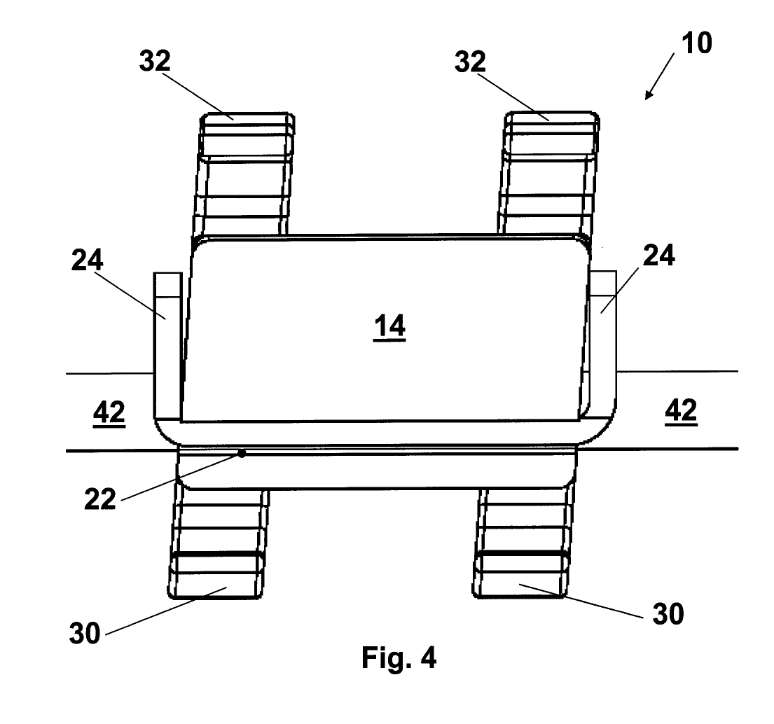

FIG. 4 is a rear view of the orthodontic bracket of FIG. 1, illustrating reception of an arch wire 42 in the arch wire slot 16. A spring slot 22 is formed in the body 14 (or “stem”) of the bracket 10 for insertion of the spring web 26 prior to laser welding the bonding pad 12 to the body 14.

The spring 24 is manufactured from one or more of different types of materials including all shape memory alloys, steel, plastics and ceramics, or a combination of these materials.

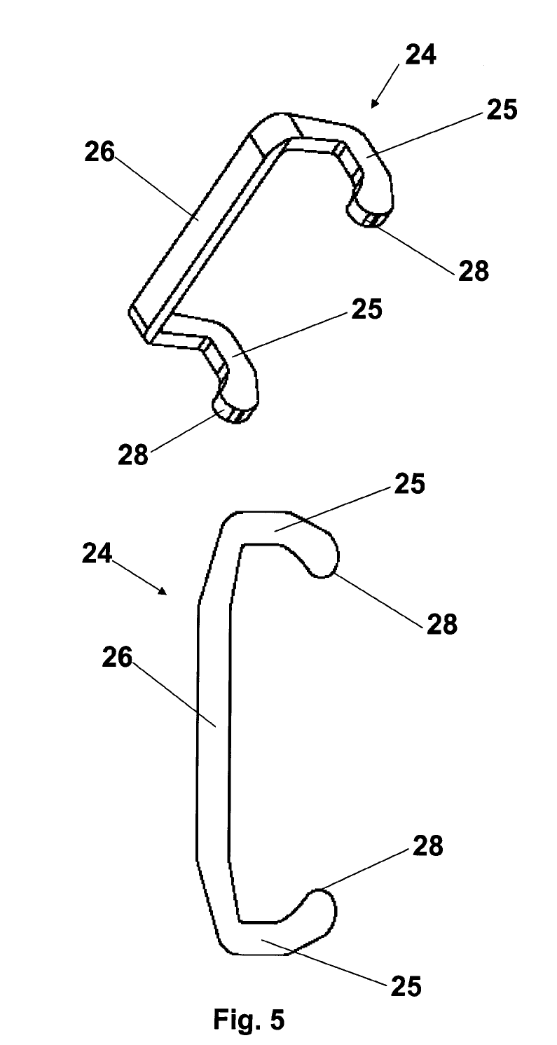

FIG. 5 is an elevational view of a single continuous spring 24 used in the bracket 10 of FIG. 1 having been stamped from nickel titanium or steel and then formed for association with the bracket 10. The spring 24 begins as a planar piece as shown in the upper drawing, and the fingers 25 are then bent relative to the plane to delineate the fingers 25 from the connecting web 26, as in the lower drawing.

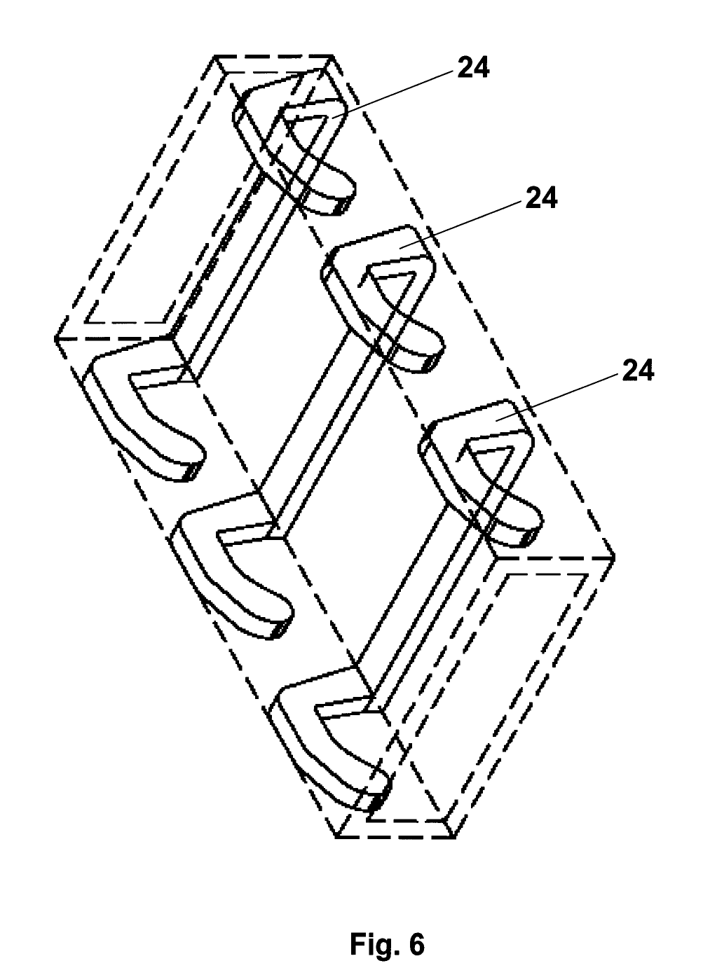

FIG. 6 is a perspective view of an extruded rectangular nickel titanium tube and the alternative method by which a single continuous spring 24 may be laser cut from the tube. In this method, the spring 24 is cut from the tube in generally finished form and does not require bending relative to a plane for formation.

The spring 24 is quite flexible and is formed to deflect much more easily than prior art retention devices. This is because it is the sum total force of all springs 24 in a system of brackets 10 that cooperate to retain the arch wire, such that no single bracket 10 in a system truly needs to be responsible for 100% of the arch wire retention. The orientation of the spring 24 may also be used as a means within a system of brackets 10 to retain the arch wire. For example, in the maxillary arch the spring 24 is located on the gingival tie wing side of the arch wire slot 16 in the central, lateral and cuspid brackets. The bicuspid and 1^{st} molar brackets feature the spring 24 oriented to the occlusal, on the opposite side of the arch wire slot 16, to aid in mechanical retention of smaller diameter round arch wires 40. This is easily accomplished because in a straightwire system the maxillary central, lateral and cuspid brackets all feature positive torque values in the arch wire slot while the bicuspid and molar brackets feature negative torque values.

The orthodontic bracket shown above may be used in a system of similar brackets in the arch with 1^{st} or 2^{nd} molar buccal tubes for receiving the ends of the arch wire. During installation of an arch wire 40 by a practitioner, the ends of the arch wire 40 are first inserted into the buccal tubes as is known in the art, and then the arch wire is rested on each bracket in the system between the tie wings by virtue of the above-described tiewing offset 50. To finalize the installation, the arch wire 40 is then pushed towards the respective bracket bases against all of the brackets' springs 24 to deflect the springs 24 together and enter the arch wire slots 16 of the brackets 10. Because the curved tip of the spring fingers 25 only slightly block the mesial and distal ends of arch wire slot 16 cross-sectionally at its opening 18 and part of its midsection in conjunction with the chamfer 20 in the opposite slot entrance on the tie wings 30, 32, the fingers 25 require very little deflection in order to insert or remove the arch wire 40. Removal of the arch wire 40 requires simply reversing the steps described above for installation.

Removal and installation therefore do not require individual manipulation of latches or clips. Rather, the entire arch wire 40 may be removed in a single movement.

A system of brackets employing the above-described single continuous spring only requires that the slot opening 16 be covered enough to allow smaller nominal size round wires to be inserted and retained during leveling and alignment. In some cases these nominally sized round wires (commonly 0.014 or 0.016 in a 0.0185×0.025 arch wire slot 16 or 0.016 or 0.018 in a 0.0225×0.0285 arch wire slot) may briefly require a ligature during the leveling and aligning phases. As will be understood, these phases constitute only a small percentage of treatment time.

Because of the cooperation of the sum total force of all the springs 24 working together and the 1^{st} or 2^{nd} molar buccal tubes during initial and finishing torquing, the force required for deflection of a single one of the springs 24 in a system of brackets need not be nearly as great as has been the case in the prior art devices described above. A benefit of the smaller required deflection force is that entry or exit of the arch wire 40 does not require the extensive use of special tools for spring deflection. Installation is therefore greatly simplified. Furthermore, the return of each spring 24 to its position after deflection either during arch wire insertion or removal does not cause the discomfort associated with the prior art devices described above. The curved terminal portions 28 also permit smooth deflection and return during insertion or removal when compared with sharp terminal portion edges that permit the spring to snap back into its rest position once the arch wire is past.

Alternatively, the shape-memory properties of a Nickel-Titanium (NiTi) spring can be employed to assist with insertion and removal of arch wires. Based on the relative amount of nickel to titanium, the NiTi spring will have a transition temperature below which it becomes soft and pliable. A clinician may slightly cool the spring in order to insert an arch wire. When the spring becomes warmer than its transition temperature, it assumes its curved shape and can retain an arch wire. In a similar manner, removal of the arch wire may be facilitated by slightly cooling the spring below its transition temperature in order to make it soft and pliable. Typically, the Ni:Ti ratio will be chosen such that the transition temperature of the NiTi spring is around room temperature.

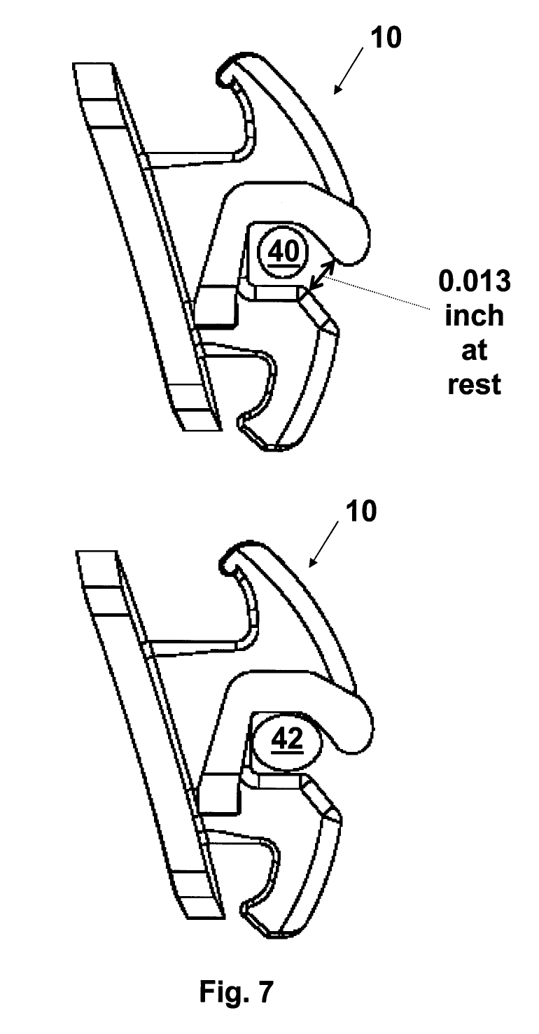

FIG. 7 is side views of the orthodontic bracket of FIG. 1, having received a 0.016 inch round arch wire 40 (upper diagram) and a 0.016 inch×0.020 inch oval arch wire 42 (lower diagram) in its arch wire slot 16. It can be seen that the round arch wire 40 when received is relatively unseated as appropriate during the initial aligning and leveling phases. As increased torque expression is required during treatment, the oval arch wire 42 is used and may be increasingly caused to contact the portion of the spring fingers 25 which extend to block at the mesial and distal ends the cross-sectional midsection of the arch wire slot 16.

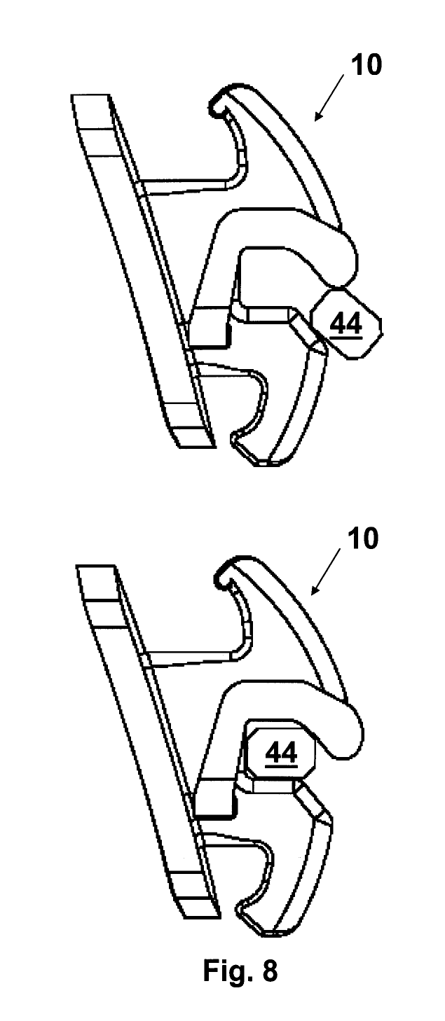

FIG. 8 is side views of the orthodontic bracket of FIG. 1, receiving a six-sided finishing arch wire 44 in its arch wire slot 16. The six-sided arch wire 44 is used for increased expression of torque due to the portion of the spring fingers 25 which extend to block at the mesial and distal ends of the slot the cross-sectional midsection of the arch wire slot increasingly contacting the six-sided arch wire 44.

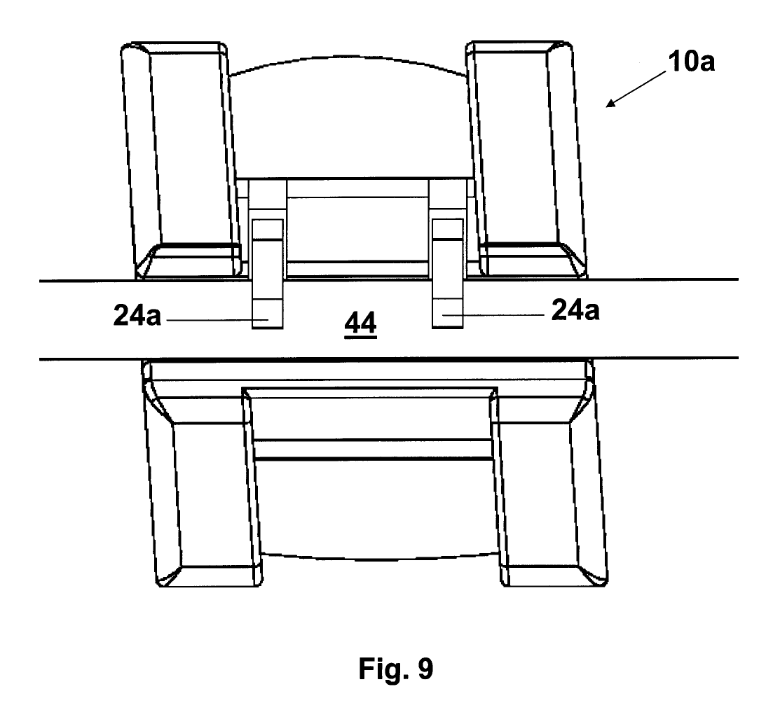

FIG. 9 is a front view of an orthodontic bracket 10a according to an alternative embodiment, having received a round arch wire 44 in its arch wire slot 16. According to this embodiment, the spring 24a does not straddle the bracket body 14. Rather, the spring 24a is positioned such that the tips 28a of its fingers 25a extend downwards into the arch wire slot 16 between the tie wings 30, 32. The spring 24a shown in FIG. 9 has a web 26a of reduced length when compared with that shown above that straddles the bracket body 14.

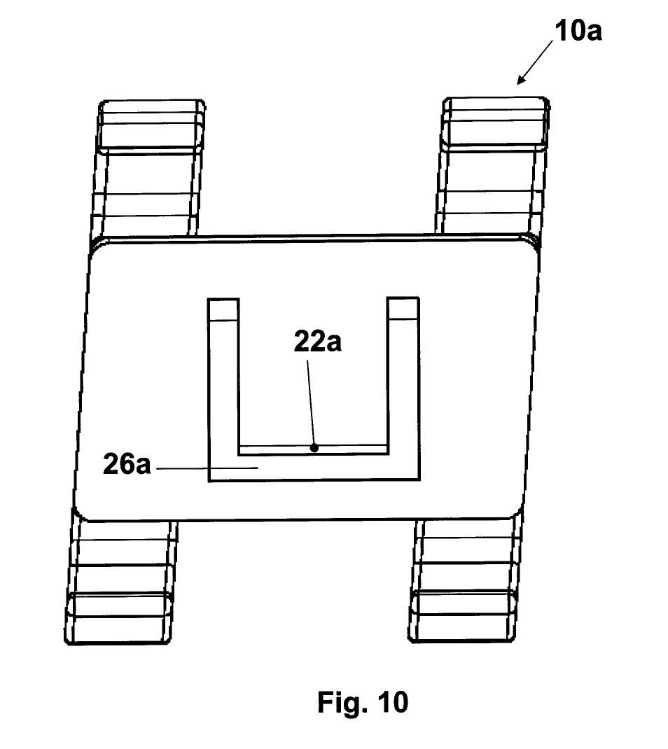

FIG. 10 is a rear view of the orthodontic bracket 10a of FIG. 9. A U-shaped spring slot 22a is formed in the body 14 (or “stem”), of the bracket 10a for insertion of the spring web 26a prior to laser welding the bonding pad 12 to the body 14.

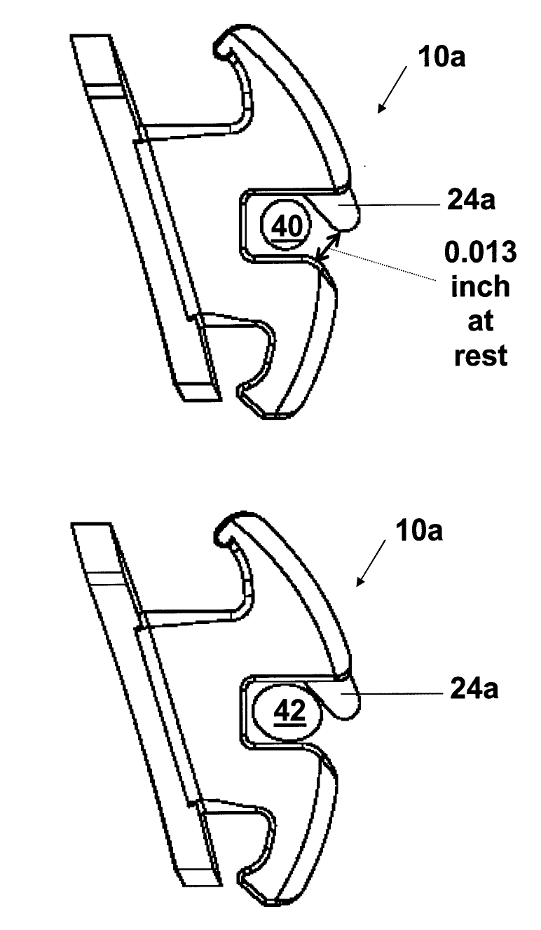

FIG. 11 is side views of the orthodontic bracket 10a of FIG. 9, having received a 0.016 inch round arch wire 40 (upper diagram) and a 0.016 inch×0.020 inch oval arch wire 42 (lower diagram) in its arch wire slot 16. It can be seen that the round arch wire 40 when received is relatively unseated as appropriate during the initial aligning and leveling phases. As increased torque expression is required during treatment, the oval arch wire 42 is used and may be increasingly caused to contact the portion of the spring fingers 25a which extend to block between the tiewings 30, 32 the cross-sectional midsection of the arch wire slot 16.

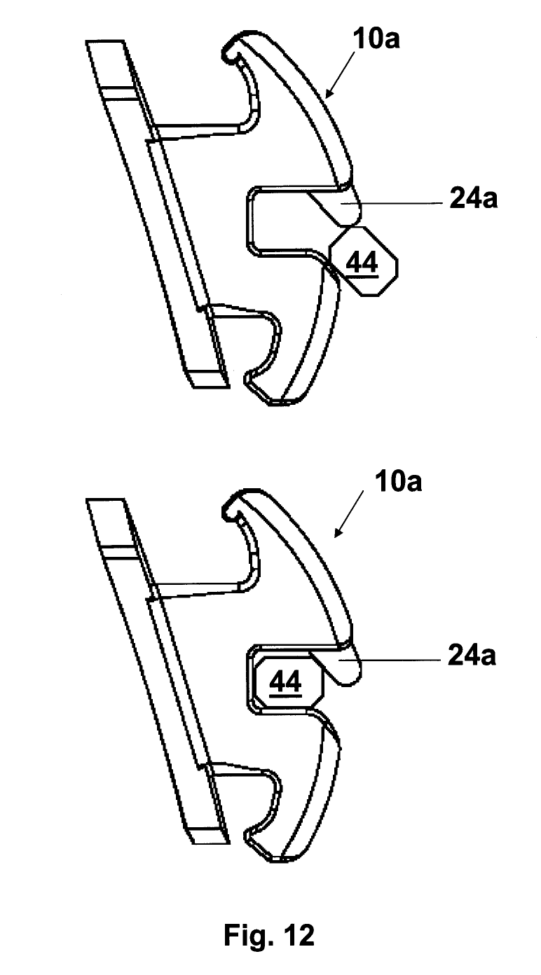

FIG. 12 is side views of the orthodontic bracket of FIG. 9, receiving a six-side finishing arch wire 44 in its arch wire slot 16. The six-sided arch wire 44 is used for increased expression of torque due to the portion of the spring fingers 25a which extend to block the cross-sectional midsection of the arch wire slot between the tiewings 30, 32 thereby increasingly contacting the six-sided arch wire 44.

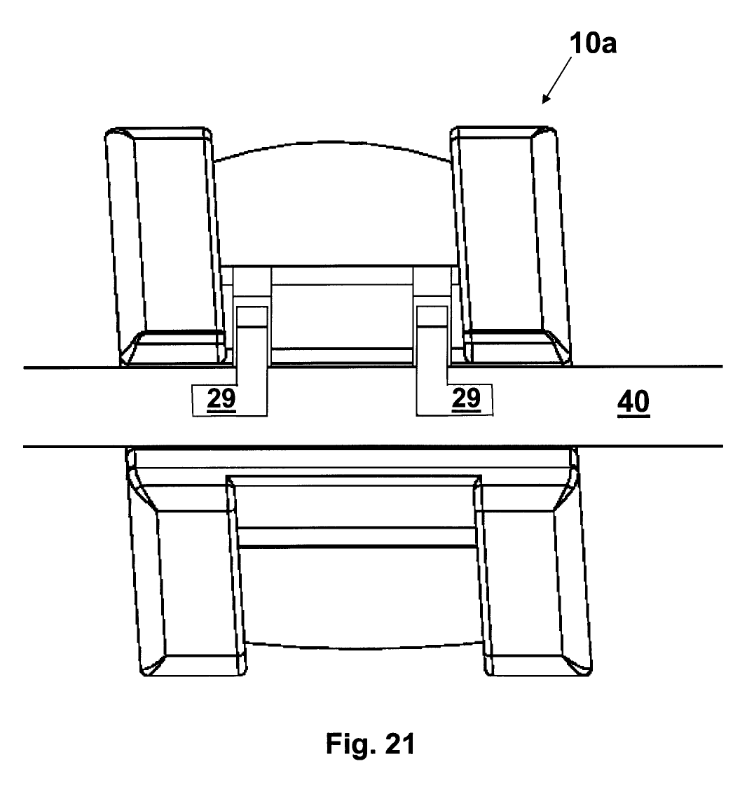

Shown in FIG. 21 is a front view of an orthodontic bracket that is similar to that shown in FIGS. 9 through 12, with the difference being that its terminal portions are L-shaped, rounded bars 29 that contact the arch wire during insertion or removal. Other such alternatives may be contemplated, including those with the bottom section of the “L” pointing another way, and T-shaped terminal portions.

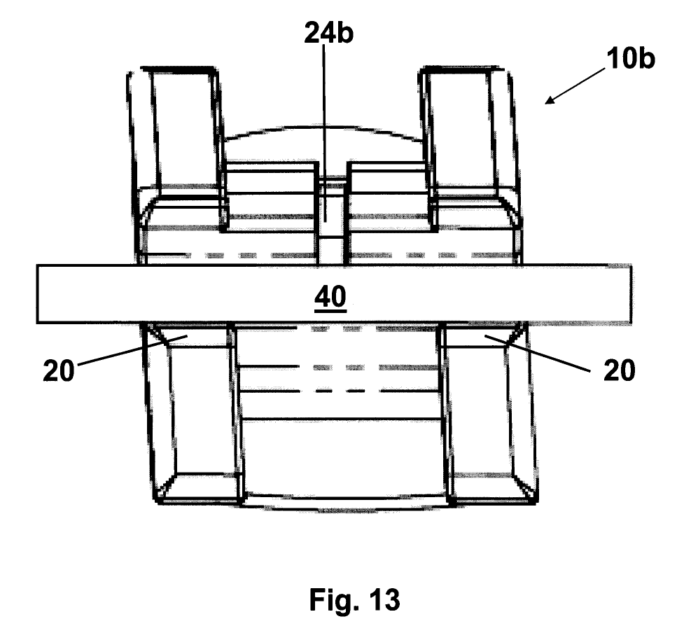

FIG. 13 is a front view of an orthodontic bracket 10b according to another alternative embodiment with an arch wire 42 ready for insertion into its arch wire slot 16. According to this embodiment, the spring 24b comprises a single finger 25b protruding from a flange 27b that functions as the spring base. The single finger spring 24b is for use on narrow brackets required for lower central, lateral and upper lateral teeth. The flange 27b is received in a spring slot 22b in the body 14 of the bracket 10b and the finger 25b protrudes between the tie wings 30, 32 and into the arch wire slot 16 in a manner similar to the spring embodiment having two fingers 25a shown in FIGS. 9-12.

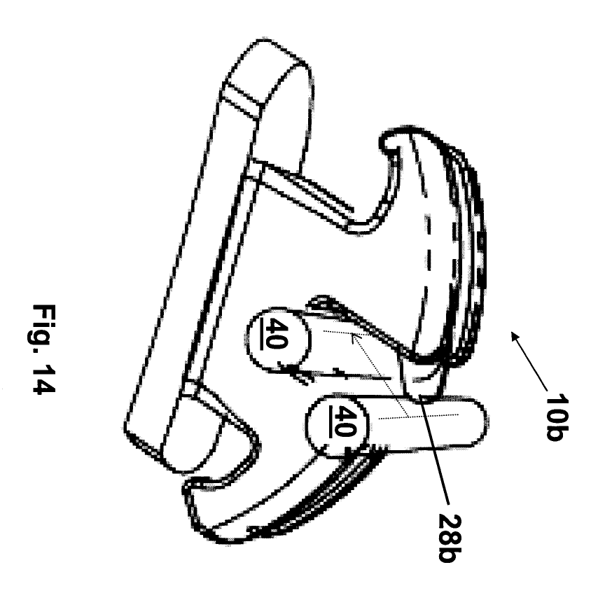

FIG. 14 is a side view of the orthodontic bracket 10b of FIG. 13 with an arch wire 40 being inserted into its arch wire slot 16. The single finger 25b is being deflected as the arch wire 40 is being pushed up the chamfer 20 into the arch wire slot 16.

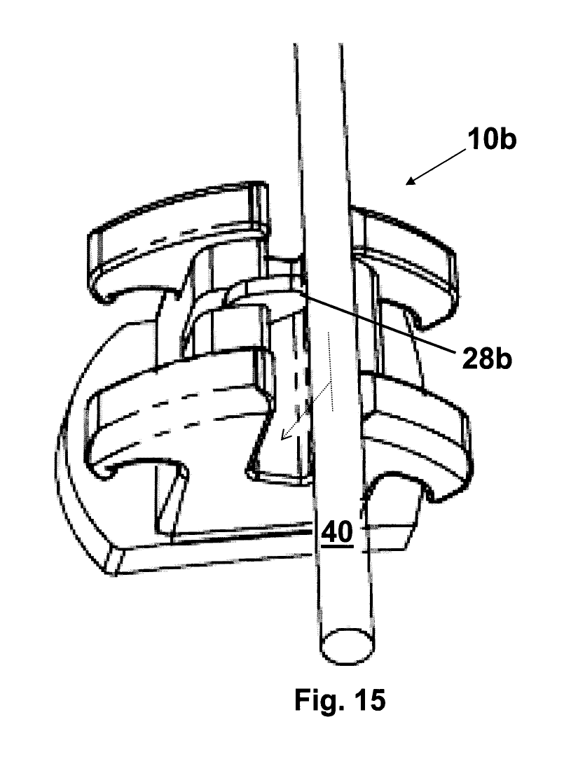

FIG. 15 is a slightly raised side view of the orthodontic bracket 10b with the partially inserted arch wire 40 of FIG. 14.

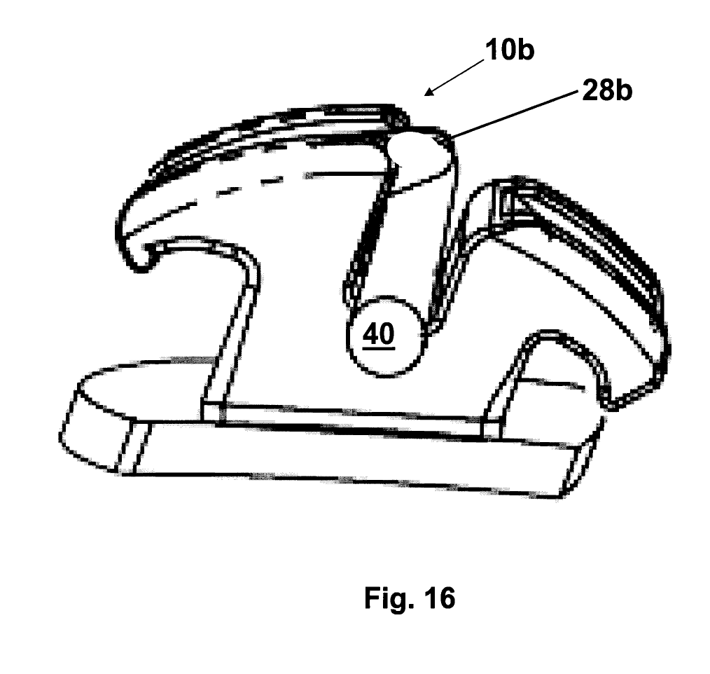

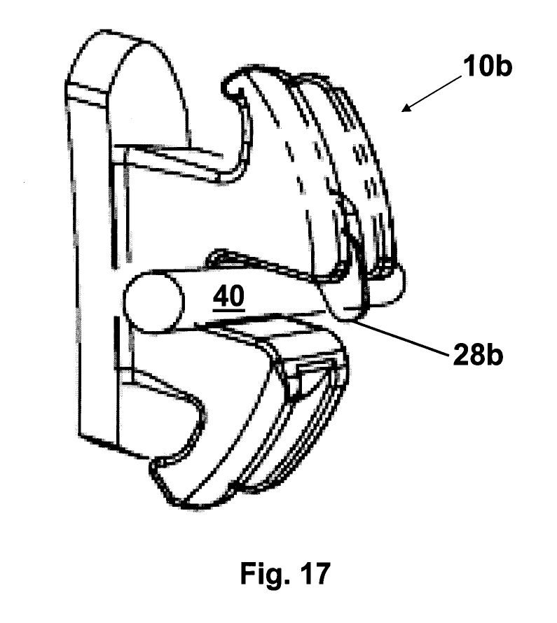

FIG. 16 is a side view of the orthodontic bracket 10b of FIG. 13 with the arch wire 40 having been inserted into its arch wire slot 16. FIG. 17 is a side view of the orthodontic bracket 10b of FIG. 13 with the arch wire 40 having been inserted into its arch wire slot 16 and showing in more detail the dimension of the curved tip 28b of the finger 25b of the spring 24b for retaining and seating arch wires of various dimensions.

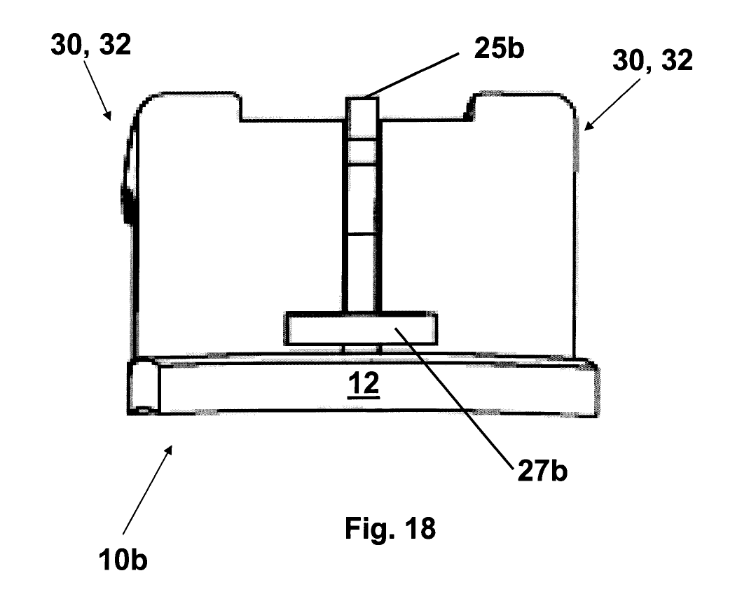

FIG. 18 is an occlusal sectional view of the orthodontic bracket 10b of FIG. 13 showing the relationship between the body 14 of the bracket 10 and the single finger spring 25b. The spring slot 22b includes a hole through the body 14 of the bracket 10 with a countersink in the side of the body 14 opposite the arch wire slot 16. During assembly of the bracket 10b, the finger 25b is passed through the spring slot 22b such that its flange 27b rests generally flush with the side of the body 14 opposite the arch wire slot 16. Once the finger spring 25b is inserted into the counter-sunk hole, the bonding pad 12 is laser welded to the body 14.

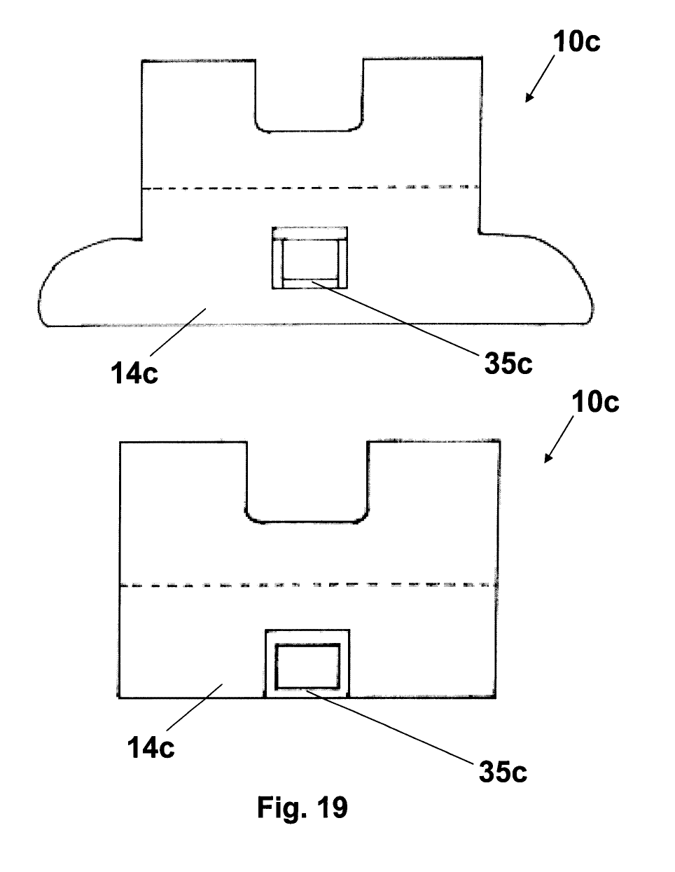

FIG. 19 is occlusal views of brackets 10c formed at least partially of ceramic. In both views, a metal insert 35c is received by a ceramic body 14c (in two alternative configurations as shown) to, in turn, receive the spring (not shown, but such as spring 24b) and bear the mechanical pressures which would otherwise be borne by the more brittle ceramic body 14c of the bracket 10c during deflection of the spring.

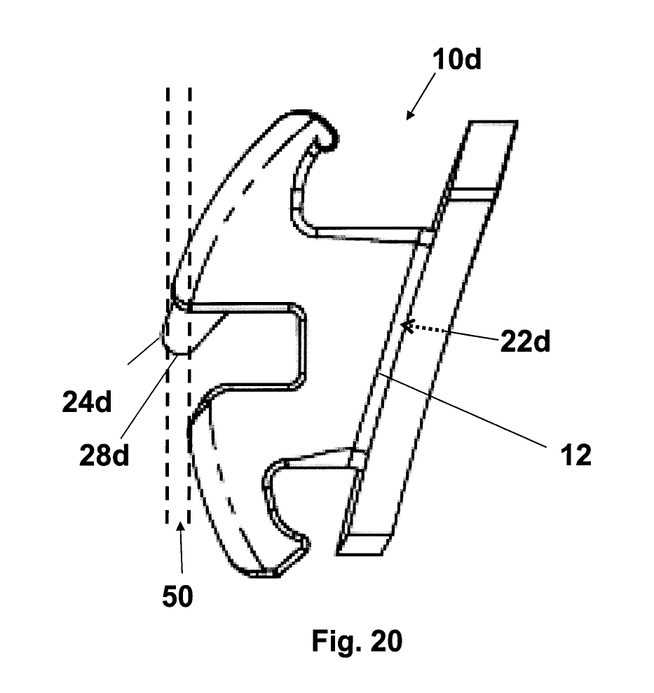

FIG. 20 is a side view of an orthodontic bracket according to an alternative embodiment, in which a spring 24d is retained in a spring slot 22d adjacent to the bonding pad.

Although specific embodiments have been described and illustrated, those of skill in the art will appreciate that the variations and modifications may be made without departing from the spirit and scope thereof as defined by the appended claims.

For example, springs with a single finger or multiple fingers of various configurations have been shown to be particularly elegant and advantageous to the embodiments disclosed herein. However, it will be understood that other springs such as combinations of coil springs or spring-cushioned ball bearings may function effectively to seat full-sized arch wires into the arch wire slot, while also being capable of functioning to retain arch wires of a range of sizes in the arch wire slot. Furthermore, multiple springs of the same or other complementary configurations may be employed in order to achieve the functions described for the arch wire retention device.

According to some embodiments, the springs described herein have been formed of a shape memory alloy called nickel-titanium alloy. Such a material is advantageous during manufacture, because when cooled, it is pliable and easy to insert into the bracket, and also may be cooled in order to facilitate insertion and/or removal of an arch wire. When brought back up to body temperature range, the material reverts to its curved shape and assumes its springing properties. However, one of ordinary skill in the art would understand that, for example, springs of different materials such as steel, chrome-cobalt alloy, titanium-molybdenum alloy, or molded shape-memory plastics would function, and relate to the body of the bracket in much the same manner as described above. Shape-memory plastics, however, are generally required to be warmed above a transition temperature (rather than cooled below a transition temperature as with NiTi) in order to become soft and pliable. As such, a clinician would warm the shape-memory plastic spring or springs in order to facilitate insertion and removal of an arch wire.

In the embodiments shown, the spring in its rest position obstructs only slightly more of the slot opening than the diameter of the smallest round arch wire. This configuration is advantageous for ease of insertion of an arch wire into the slot. However, within the scope of the invention are embodiments in which the spring in its rest position could obstruct more of the opening. The amount of deflection, however, would generally be increased making installation or removal of the arch wire more difficult. However, in cases where a shape-memory material is used for the spring, the shape-memory material may be cooled (or warmed as may be the case if shape-memory plastic is used) to enable the arch wire to enter/exit the slot without requiring the arch wire to exert very much force on the spring against its bias during entry/exit.

Furthermore, while the smallest dimension of arch wire retained by the retention device in the embodiments disclosed above is 0.012 inches, it will be understood that different situations and applications of the present invention may find need for configurations which permit retention of smaller arch wires. It is also conceivable that, depending on patient requirements or preference of the clinician, the arch wire slot of the orthodontic appliance described herein may receive multiple arch wires, as would be understood by one of ordinary skill in the art.

What is claimed is:

1. An orthodontic appliance, comprising:
a base for bonding the appliance to a tooth;
a body extending from the base;
an arch wire slot extending across the body in a generally mesial-distal direction and opening in a generally buccal-labial direction, the body having a chamfer that widens the arch wire slot at its opening; and
a resilient retention device associated with said slot and having a terminal portion opposite the chamfer when in a resting position to permit both entry and removal of an arch wire from said slot.

2. The orthodontic appliance of claim 1, wherein the retention device comprises a spring for exerting force on a retained arch wire having a predetermined minimum dimension within the arch wire slot.

3. The orthodontic appliance of claim 2, wherein the spring includes a single finger within the arch wire slot.

4. The orthodontic appliance of claim 2, wherein the spring comprises two integral fingers inside of the arch wire slot on either side of a midline of the bracket.

5. The orthodontic appliance of claim 2, wherein the spring comprises two integral fingers outside of the arch wire slot on a respective mesial/distal side of the body and connected by a mesial-distal web.

6. The orthodontic appliance of claim 1, wherein the chamfer is dimensioned to function as a resting place for an arch wire prior to its insertion into the arch wire slot.

7. The orthodontic appliance of claim 1, wherein the retention device terminal portion and the opposite side of the arch wire slot are spaced from each other in the resting position of the retention device.

8. The orthodontic appliance of claim 7, wherein the maximum space between the retention device terminal portion in its resting position and the opposite side of the arch wire slot is between 0.008 and 0.013 inches.

9. The orthodontic appliance of claim 1, wherein the terminal portion of the retention device is shaped to cooperate with an arch wire and the chamfer during entry or removal of the arch wire to smoothly deflect the retention device to and from its resting position.

10. The orthodontic appliance of claim 1, wherein the terminal portion is curved.

11. The orthodontic appliance of claim 1, wherein the terminal portion comprises at least one rounded bar extending in a mesial-distal direction.

12. The orthodontic appliance of claim 1, wherein the terminal portion is generally T-shaped.

13. The orthodontic appliance of claim 1, wherein the terminal portion is generally L-shaped.

14. The orthodontic appliance of claim 1, wherein the retention device is generally J-shaped.

15. The orthodontic appliance of claim 1, wherein the chamfer is formed in an occlusal portion of the body.

16. The orthodontic appliance of claim 1, wherein the retention device is formed of one of plastic, metal, ceramic, nickel-titanium, and shape-memory plastic, and/or a combination thereof.

17. The orthodontic appliance of claim 1, wherein the retention device and the chamfer cooperate to permit both entry and removal respectively of circular, rectangular, oval, 5-sided and six-sided arch wires.

18. The orthodontic appliance of claim 2, wherein the spring is anchored within a spring slot in the body against the base.

19. The orthodontic appliance of claim 1, wherein the angle between the chamfer and the rest of the arch wire slot is from 5 to 60 degrees.

20. The orthodontic appliance of claim 1, further comprising tiewings extending from said body.

21. An orthodontic system for receiving an arch wire, said system comprising:
an arch wire;
a plurality of brackets, each of said brackets bondable to a respective tooth and comprising:
a body;
an arch wire slot extending across the body in a generally mesial-distal direction and opening in a generally buccal-labial direction, the body having a chamfer that widens the arch wire slot at its opening; and
a resilient retention device associated with said slot and having a terminal portion opposite the chamfer in its resting position to permit both entry and removal of the arch wire from said slot;
said orthodontic system further comprising second molar appliances for receiving a respective end of said arch wire.

22. The orthodontic system of claim 21, wherein the sum total force of a plurality of the retention devices retains the arch wire within the brackets' arch wire slots.
